(19) United States
(12) Patent Application Publication
(10) Pub. No.: US 2023/0166191 A1
(43) Pub. Date: Jun. 1, 2023

(54) PROGRAM, METHOD, SYSTEM, AND ELECTRONIC DEVICE

(71) Applicant: CYGAMES, INC., Tokyo (JP)

(72) Inventors: Takuma Akitsu, Tokyo (JP); Hironori Sato, Tokyo (JP); Yujiro Deguchi, Tokyo (JP); Kentaro Umeda, Tokyo (JP)

(73) Assignee: CYGAMES, INC., Tokyo (JP)

(21) Appl. No.: 18/154,425

(22) Filed: Jan. 13, 2023

Related U.S. Application Data
(63) Continuation of application No. PCT/JP21/25730, filed on Jul. 8, 2021.

(30) Foreign Application Priority Data
Jul. 14, 2020 (JP) 2020-120380

(51) Int. Cl. A63F 13/58; A63F 13/533; A63F 13/537; A63F 13/825

(52) U.S. Cl. CPC A63F 13/58; A63F 13/533; A63F 13/537; A63F 13/825

(57) ABSTRACT

An electronic device includes: a raising-game-medium acceptance unit for accepting a raising game medium that is selected by a player and that is to be raised in a raising game; an inherited-game-medium acceptance unit for accepting, as an inherited game medium, a raised game medium selected from a group of raised game media including a plurality of raised game media the raising of which has been completed by the player in the raising game; and a raising-game execution unit for executing the raising game in which the raising game medium is to be raised, changing a raising parameter varying in the raising game on the basis of at least one item of property information possessed by the inherited game medium, and generating a raised game medium by associating a character ID included in the raising game medium with the raising parameter upon completion of the raising game.

### TECHNICAL FIELD

The present invention relates to a program, etc., and in particular to a program, etc. for a raising game in which a game medium selected by a player is raised.

### BACKGROUND ART

In recent years, with the rapid spread of electronic devices including smartphones, many games executed on electronic devices have been released. Among this type of games, games in which a game medium, such as a racehorse, is raised are known. There are well-known simulation games in which a player selects a stallion and a mare, serving as parent horses, and produces and raises a child horse from these parent horses (refer to, for example, PTL 1).

### CITATION LIST

### Patent Literature

### {PTL 1}

Japanese Unexamined Patent Application, Publication No. 2002-126349

### SUMMARY OF INVENTION

### Technical Problem

In this type of games, a player can select game media for two parent horses. However, these types of games have a problem in that there is no room for the player to select a game medium for a child horse to be raised because a game medium for the child horse is automatically generated by the game program on the basis of the selected game media for the parent horses. Such a problem is not limited to games for producing and raising racehorses but is common to games including raising games for raising any game medium.

The present invention has been conceived in order to solve such a problem, and an object thereof is to provide a program, a method, a system, and an electronic device that can enhance the fun of a game.

### Solution to Problem

A program according to an aspect of the present invention is a program that executes a game including a main competition game in which a player uses a game medium and a raising game in which the player raises the game medium, said program causing a computer to function as: a raising-game-medium acceptance means for accepting a raising game medium that is selected by the player and that is to be raised in the raising game; an inherited-game-medium acceptance means for accepting, as an inherited game medium, a raised game medium selected from a group of raised game media including a plurality of raised game media the raising of which has been completed by the player in the raising game; and a raising-game execution means for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.

A method according to an aspect of the present invention is a method for executing, by means of an electronic device, a game for raising a game medium in a raising game so that the game medium is used by a player in a main game competition, said method including: a raising-game-medium acceptance step for accepting a raising game medium that is selected by the player and that is to be raised in the raising game; an inherited-game-medium acceptance step for accepting, as an inherited game medium, a raised game medium selected from a group of raised game media including a plurality of raised game media the raising of which has been completed by the player in the raising game; and a raising-game execution step for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.

A system according to an aspect of the present invention is a system for executing a game for raising a game medium in a raising game so that the game medium is used by a player in a main game competition, said system including: a user terminal; and a server connected to the user terminal via a network, wherein the user terminal or the server functions as a raising-game-medium acceptance means for accepting a raising game medium that is selected by the player and that is to be raised in the raising game, the user terminal or the server functions an inherited-game-medium acceptance means for accepting, as an inherited game medium, a raised game medium selected from a group of raised game media including a plurality of raised game media the raising of which has been completed by the player in the raising game, and the user terminal or the server functions as a raising-game execution means for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.

An electronic device according to an aspect of the present invention is an electronic device for executing a game for raising a game medium in a raising game so that the game medium is used by a player in a main game competition, said electronic device including: a raising-game-medium acceptance means for accepting a raising game medium that is selected by the player and that is to be raised in the raising game; an inherited-game-medium acceptance means for accepting, as an inherited game medium, a raised game medium selected from a group of raised game media including a plurality of raised game media the raising of which has been completed by the player in the raising game; and a raising-game execution means for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.

### Advantageous Effects of Invention

According to the present invention, it is possible to enhance the fun of a game.

### BRIEF DESCRIPTION OF DRAWINGS

FIG. 1 is a block diagram showing the hardware configuration of an electronic device according to an embodiment of the present invention.

FIG. 2 is an example of a functional block diagram of the electronic device according to an embodiment of the present invention.

FIG. 3 is an example of a functional block diagram of a game control unit.

FIG. 4 is an example of a raising-game-medium selection screen.

FIG. 5 is an example of an inherited-game-medium pre-selection screen.

FIG. 6 is an example of an inherited-game-medium selection screen.

FIG. 7 is an example of an inherited-game-medium confirmation screen.

FIG. 8 is an example of a functional block diagram of a raising-game execution unit.

FIG. 9 is another example of the inherited-game-medium confirmation screen.

FIG. 10 is a training command selection screen for training a raising game medium in a raising game.

FIG. 11 is a skill acquisition screen of a raising game.

FIG. 12 is an example of a flowchart for the operation of the electronic device according to an embodiment of the present invention.

FIG. 13 is a diagram showing an example of the overall structure of a game system according to an embodiment of the present invention.

### DESCRIPTION OF EMBODIMENTS

A game system according to an embodiment of the present invention will now be described with reference to the drawings. In this description, there are cases where descriptions that are more detailed than necessary are omitted for convenience of explanation. For example, there are cases where detailed descriptions of matters that are already well known and repeated descriptions of substantially the same configurations are omitted.

This game system can be realized by a system having a plurality of electronic devices connected via a network, but can also be realized by a single electronic device. First, an embodiment realized by a single electronic device is described, and then a system connected to a network is described.

### {Embodiments Realized by an Electronic Device}

### {Configurations}

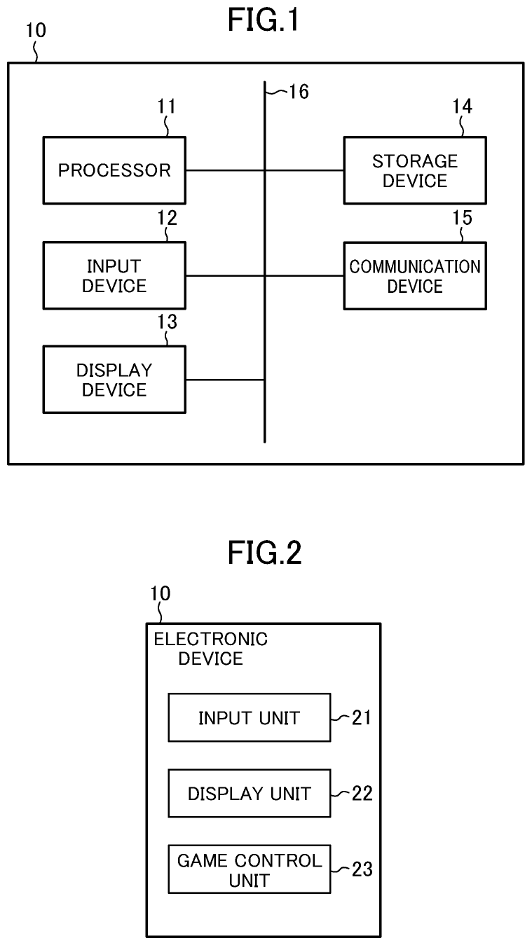

FIG. 1 is a block diagram showing the hardware configuration of an electronic device 10 according to an embodiment of the present invention. The electronic device 10 includes a processor 11, an input device 12, a display device 13, a storage device 14, and a communication device 15. The configurations 11 to 15 are connected via a bus 16. Note that an interface may be interposed, as needed, between the bus 16 and each of the configurations 11 to 15. In this embodiment, the electronic device 10 is a smartphone. Alternatively, the electronic device 10 may be a computer, such as a tablet computer, a notebook personal computer, and a desktop computer, as long as the computer includes the configurations described above.

The processor 11 controls the overall operation of the electronic device 10 and is, for example, an electronic circuit, such as a CPU or an MPU. The processor 11 executes various types of processing by loading programs and data stored in the storage device 14 and then executing the programs. In one example, the processor 11 is constituted of a plurality of processors.

The input device 12 is a user interface for accepting inputs to the electronic device 10 from a user. The input device 12 is, for example, a touchscreen, a touchpad, a keyboard, or a mouse. Because the electronic device 10 in this embodiment is a smartphone, the electronic device 10 includes a touchscreen, which functions both as the input device 12 and as the display device 13. The input device 12 and the display device 13 may be discrete devices that are located at different positions.

The display device 13 presents the user of the electronic device 10, i.e., the player, with application screens, etc. under the control of the processor 11. For the display device 13, a liquid crystal display, an organic EL display, a plasma display, or the like can be used.

The storage device 14 includes a main memory, a buffer memory, and a storage and is a storage device provided in a general smartphone or computer, typified by a storage device using a RAM (volatile memory) or a flash memory (nonvolatile memory), such as an eMMC, a UFS, or an SSD, as well as a magnetic storage device. The storage device 14 can include an external memory. The storage device 14 stores, for example, a game application. A game application includes a game program for executing a game and various types of data that are referenced when the game program is executed. The game program is started in response to a user operation on the electronic device 10 and is executed on the operating system (OS) pre-installed in the electronic device 10.

In one example, the storage device 14 includes a main storage device and an auxiliary storage device. The main storage device is a volatile storage medium capable of high-speed reading and writing of information, and is used as a storage area and a work area when the processor 11 processes information. The auxiliary storage device stores various types of programs, as well as data that are used by individual programs when the programs are executed. The auxiliary storage device is, for example, an SSD or a hard disk device; however, the auxiliary storage device may be any type of nonvolatile storage or nonvolatile memory, which may be of the removable type, that is capable of storing information. For example, the auxiliary storage device stores the operating system (OS), middleware, application programs, various types of data that may be referenced when these programs are executed, etc.

The communication device 15 transmits data to and receives data from other computers, such as servers, via a network. For example, the communication device 15 performs wireless communication, such as mobile communication or wireless LAN communication, to connect to the network. In one example, the electronic device 10 downloads a program from a server by means of the communication device 15 and stores the program in the storage device 14. Alternatively, the communication device 15 may perform wired communication by using, for example, an Ethernet® cable. In the case where data is neither transmitted to nor received from other computers, the electronic device 10 need not include the communication device 15.

FIG. 2 is an example of a functional block diagram of the electronic device 10 according to an embodiment of the present invention. The electronic device 10 includes an input unit 21, a display unit 22, and a game control unit 23. In this embodiment, these functions are realized by the processor 11 executing a program. For example, the program that is executed is a game program stored in the storage device 14 or a game program received via the communication device 15. Since various types of functions are realized by loading a program, as described above, a portion or the entirety of one part (function) may be provided in another part. These functions may be realized by means of hardware by configuring electronic circuits or the like for realizing the individual functions in part or in entirety.

The input unit 21 is constituted using the input device 12 and accepts inputs to the electronic device 10 from the user. In this embodiment, a touch detection function that is provided in touchscreens and that is commonly possessed by smartphones can be used.

The display unit 22 is constituted using the display device 13 and displays, on the display device 13, a game screen according to the game progress and a user operation. The game control unit 23 performs basic control in executing the game in this embodiment. The game in this embodiment includes a main competition game and a raising game. More specifically, the game player raises a game medium in the raising game and uses the raised game medium in the main competition game. A game medium is electronic data used in a game, such as a character, a weapon, an item, a card, or an item of equipment. Game media in this embodiment are characters.

The main competition game in this embodiment is a game in which characters in the form of game media compete for a place in the race by running a predetermined distance on a predetermined course, as in a horse race game, and the raising game in this embodiment is a game for raising a game medium that is to participate in the main competition game. This raising game is a game in which a character represented by a raising game medium is trained and raised in a scenario and in which at least one item of property information possessed by an inherited game medium (described below) is inherited by the raising game medium.

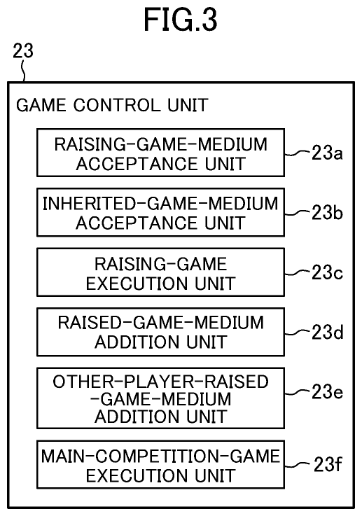

FIG. 3 is an example of a functional block diagram of the game control unit. As shown in FIG. 3, the game control unit 23 has: a raising-game-medium acceptance unit 23a; an inherited-game-medium acceptance unit 23b; a raising-game execution unit 23c; a raised-game-medium addition unit 23d; an other-player-raised-game-medium addition unit 23e; and a main-competition-game execution unit 23f.

The raising-game-medium acceptance unit 23a is configured to include the processor 11 and the input device 12 and accepts, as a raising game medium to be raised in the raising game, a material game medium selected by the player from a group of material game media.

The group of material game media is a group of game media configured to include a plurality of material game media. A material game medium is electronic data on which a raising game medium to be raised in the raising game is based, and a unique ID, an image of the character to be displayed on the display device 13, a character ID for uniquely identifying that character, and property information are associated with the material game medium. The property information of a material game medium is information indicating properties of the material game medium and is represented by, for example, parameters indicating abilities and skills of the material game medium (character). In this embodiment, a parameter is set for each of all types of property information. In other words, a predetermined parameter value (e.g., 0) can be set for an ability or a skill if the material game medium does not have that ability or skill, though different types of material game media (characters) have different abilities and skills. In addition, one of a plurality of ranks or levels, such as rarity, is associated with each of the parameters. A material game medium and the group of material game media are pre-stored in the storage device 14, such as a nonvolatile storage. It should be noted, however, that some or all of the material game media may be acquired later by the player in a probability-based lottery game or the like, so that the acquired material game media can be stored in the storage device 14. The property information of a material game medium may be enhanced by satisfying predetermined conditions, such as by consuming items. In one example, when the player consumes an item possessed by the player, the parameter value of the property information associated with the consumed item is increased. Consumption of an item in response to a player operation is performed, for example, by the raising-game-medium acceptance unit 23a.

A raising game medium is a game medium to be raised in a raising game. At the beginning stage of the raising game, the raising game medium is electronic data generated by duplicating a material game medium selected by the player from the group of material game media. However, the ID of the raising game medium is a unique ID. In other words, the raising game medium is assigned a different ID from that of the selected material game medium. For example, if the ID of a certain material game medium selected by the player is S1, then I1 is assigned as the ID of the raising game medium. In this embodiment, a unique ID, an image of the character to be displayed on the display device 13, a character ID for uniquely identifying that character, and raising parameters indicating the properties of the raising game medium are associated with the raising game medium. The image and the character ID of the character of the raising game medium are the same as the image and the character ID of the character of the material game medium.

A raising parameter is assigned to each property used in the raising game. At the beginning stage of the raising game, the raising parameters are the same as the parameters of the property information of the material game medium. Through the progress of the raising game, various types of raising parameters are added or changed. In other words, the raising parameters are variables that vary throughout the raising game. At the beginning stage of the raising game, the values of the parameters of the property information of the material game medium selected by the player are assigned to the raising parameters as initial values, and the raising parameters thus have the same parameter values as those of the property information of the selected material game medium. During the raising game, the raising parameters vary on the basis of training, at least one item of property information of an inherited game medium (described below), etc. At the completion stage of the raising game, the values of the raising parameters become the parameter values of property information of a raised game medium (described below) the raising of which has been completed in the raising game. In other words, after the completion of the raising game, the value of each of the raising parameters at the completion stage is associated with the character ID included in the raising game medium. The raising parameters need not be associated with the raising game medium during the raising game. In this embodiment, a raising parameter is defined (declared) in the raising game program and incorporated into the raising game, but is independent of the character ID, that is, is not associated with the character ID during the raising game. For example, the raising game program defines a variable for a character ID and raising parameters separately from each other. Then, when the material game medium selected by the player is duplicated, the character ID of the selected material game medium is read into the variable for the character ID, and the values of the parameters of the property information of the material game medium are read into the raising parameters. The raising game medium is stored in the storage device 14, such as a volatile recording medium. Because the raising game medium is electronic data based on a material game medium and is independent of that material game medium as described above, the material game medium is preserved without disappearing. In other words, the player can set the same material game medium as a game medium to be raised for each raising game, any number of times.

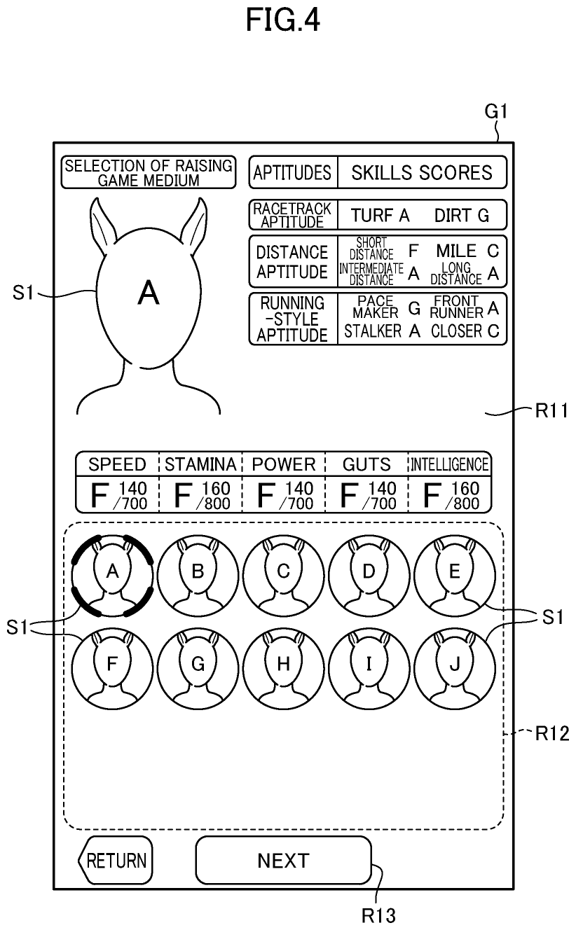

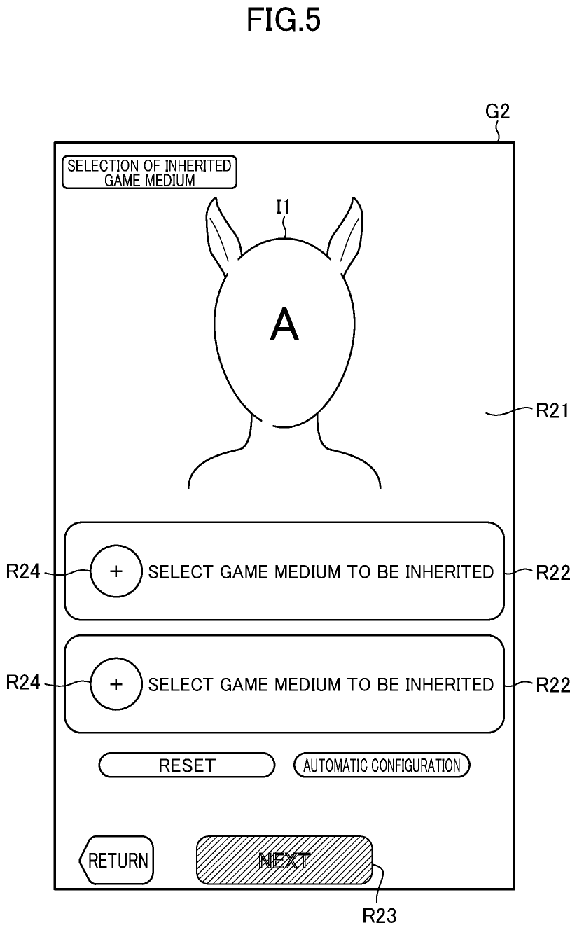

FIG. 4 is an example of the raising-game-medium selection screen. As shown in FIG. 4, the raising-game-medium acceptance unit 23a displays a raising-game-medium selection screen G1 on the display device 13 and accepts a selection of a material game medium made by the player via the input device 12. The raising-game-medium selection screen G1 includes a group-of-material-game-media display region R12, a selected-material-game-medium display region R11, and a determination button R13.

Material game media (e.g., images S1 thereof) are displayed in the group-of-material-game-media display region R12. In the example shown FIG. 4, the images S1 of a plurality of material game media (characters A to J here) are displayed. In this embodiment, because the display device 13 and the input device 12 are constituted of the touchscreen of the electronic device 10, selection of one material game medium displayed in the group-of-material-game-media display region R12 with a finger or the like of the player can be accepted.

The selected-material-game-medium display region R11 is displayed to include the image S1 and the property information of the material game medium selected from among the plurality of material game media. The property information includes, for example, basic ability parameters indicating speed, stamina, power, guts, and intelligence and aptitude parameters including racetrack aptitude, distance aptitude, and running-style aptitude. The racetrack aptitude includes, for example, an aptitude for a turf track and an aptitude for a dirt track. The distance aptitude includes, for example, a short-distance aptitude, a mile aptitude, an intermediate-distance aptitude, and a long-distance aptitude. The running-style aptitude includes a pace maker aptitude, a front runner aptitude, a stalker aptitude, and a closer aptitude. Each parameter is, for example, a numerical value, and, in addition to the numerical value, can be indicated by a rank or level, such as A, B, or C, according to the stage, as one example. For example, rank A represents the highest aptitude, and the farther from rank A, the lower the aptitude becomes. In one example, if the speed parameter is displayed with rank A, it indicates a high-speed feature, and if the speed parameter is displayed with rank G, it indicates a low-speed feature.

The determination button R13 is a button for determining that the selected material game medium is a raising game medium to be raised in the raising game. The raising-game-medium acceptance unit 23a receives a signal indicating that the input device 12 has detected the determination button R13 being pressed, identifies the material game medium that is selected in the selected-material-game-medium display region R11 at that time, duplicates the material game medium, assigns a different ID, and stores the duplicated material game medium in the storage device 14 as a raising game medium.

The inherited-game-medium acceptance unit 23b is configured to include the processor 11 and the input device 12 and accepts a raised game medium selected by the player from a group of raised game media as an inherited game medium.

The group of raised game media is a group of game media configured to include a plurality of raised game media. A raised game medium is a raising game medium the raising of which has been completed in the raising game, and a unique ID, an image of the character to be displayed on the display device 13, a character ID for uniquely identifying that character, and property information are associated with the raised game medium. The raised game medium is assigned a different ID from the ID of the raising game medium that has been raised in the raising game. For example, if the ID of the raising game medium is I1, then IZ1 is assigned as the ID of the raised game medium. The character ID may be the same across a plurality of raised game media. In the case where the player selects a material game medium and sets it as a raising game medium, and a raised game medium is generated through a raising game, the character IDs of the material game medium, the raising game medium, and the raised game medium are common. Furthermore, when the player selects again a material game medium that has been selected once and generates a raised game medium through a second raising game in which the selected material game medium serves as a raising game medium, the character ID of the raised game medium generated in the second raising game is the same as the character ID of the raised game medium generated in the first raising game. The property information of a raised game medium is information indicating properties of the raised game medium and is represented by, for example, parameters indicating abilities and skills of the raised game medium. A raised game medium and the group of raised game media are pre-stored in the storage device 14, and when a new raised game medium is generated, the new raised game medium is stored in the storage device 14.

An inherited game medium is a raised game medium selected by the player from the group of raised game media. In one example, an inherited game medium is electronic data generated by duplicating a raised game medium selected by the player.

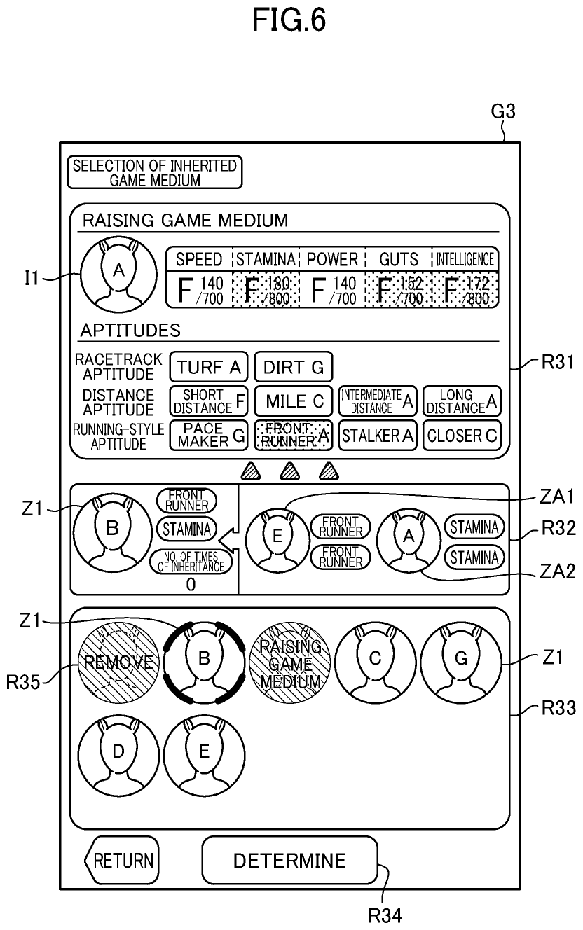

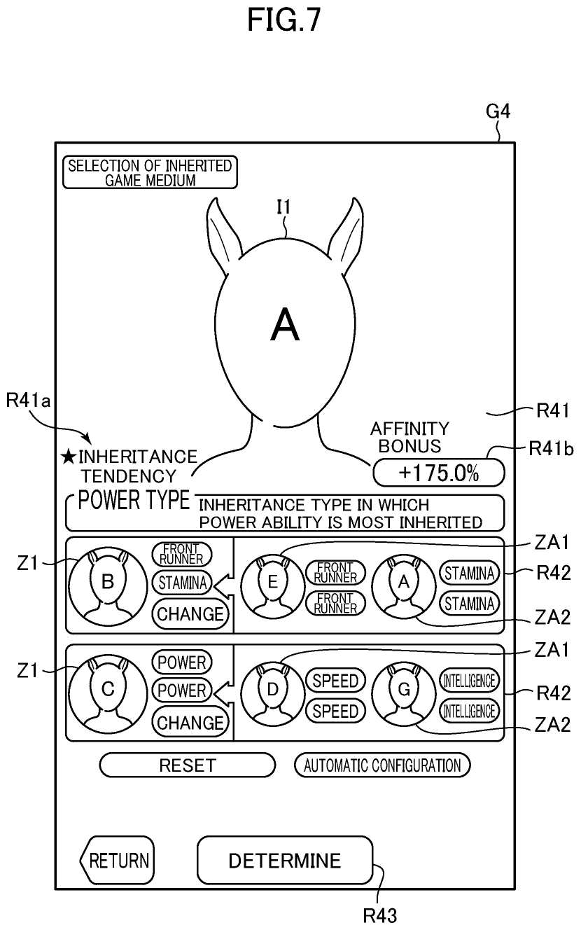

FIG. 5 is an example of an inherited-game-medium pre-selection screen. FIG. 6 is an example of an inherited-game-medium selection screen. FIG. 7 is an example of an inherited-game-medium confirmation screen. As shown in FIGS. 5 to 7, the inherited-game-medium acceptance unit 23b displays, on the display device 13, an inherited-game-medium pre-selection screen G2, an inherited-game-medium selection screen G3, and an inherited-game-medium confirmation screen G4, respectively, and accepts a selection of an inherited game medium made by the player via the input device 12. The inherited-game-medium pre-selection screen G2, the inherited-game-medium selection screen G3, and the inherited-game-medium confirmation screen G4 are screens for allowing an inherited game medium to be selected from among a plurality of raised game media.

The inherited-game-medium pre-selection screen G2 includes a raising-game-medium display region R21, inherited-game-medium selection regions R22, and a determination button R23. The raising-game-medium display region R21 is displayed to include an image I1 of the raising game medium. Each of the inherited-game-medium selection regions R22 is a region for adding an inherited game medium and includes an add button R24 for adding an inherited game medium. In this embodiment, two inherited-game-medium selection regions R22 are provided to allow two inherited game media to be selected. When the player presses an add button R24, the inherited-game-medium acceptance unit 23b displays the inherited-game-medium selection screen G3 on the display device 13.

The determination button R23 is a button for determining that the selected raised game media are inherited game media. It should be noted, however, that because no inherited game media are selected in FIG. 5, the determination button R23 is grayed out.

The inherited-game-medium selection screen G3 includes a raising-game-medium display region R31, an inherited-game-medium temporary selection region R32, a group-of-raised-game-media display region R33, and a determination button R34.

The image I1 and various types of property information of a raising game medium are displayed in the raising-game-medium display region R31, thereby making it easier to select an inherited game medium. An image Z1 and property information of a raised game medium to be selected for use as an inherited game medium are displayed in the inherited-game-medium temporary selection region R32. Next to the image Z1 and property information, images ZA1 and ZA2 and property information of the raised game media that have been set as inherited game media in the raising game in which the raised game medium selected as the inherited game medium has been raised (hereinafter, also referred to as an inheritance-originated ancestral raised game medium) are displayed. This allows the player to easily work out a strategy for a combination of the raising game medium and a raised game medium to be used as an inherited game medium. In one example, among at least two items of property information possessed by the inherited game medium or each of the inheritance-originated ancestral raised game media, two items of property information having a higher rank or level (e.g., property information with the highest rank and property information with the next highest rank) can be displayed as the property information to be displayed in the inherited-game-medium temporary selection region R32. In another example, all items of property information possessed by the inherited game medium or each of the inheritance-originated ancestral raised game media can be displayed in the inherited-game-medium temporary selection region R32. Here, the inherited-game-medium temporary selection region R32 shows that: the raised game medium represented by the character B has at least two items of property information including “front runner” and “stamina”; the inheritance-originated ancestral raised game medium represented by the character E has property information “front runner”; and the inheritance-originated ancestral raised game medium represented by the character A has property information “stamina”. The inherited-game-medium temporary selection region R32 also shows that the raised game medium represented by the character B has been raised by using the raised game media represented by the character E and character A as inherited game media.

The images Z1 of a plurality of raised game media are displayed in the group-of-raised-game-media display region R33. A remove button R35 may be displayed in this region R33. The remove button R35 is a button for decreasing the number of inherited game media. In this embodiment, two inherited game media are set, but the inherited-game-medium acceptance unit 23b can set the number of inherited game media to one as a result of the player pressing the remove button R35. In the case where the raising game medium and a raised game medium are based on the same material game medium, the raised game medium may be grayed out so as not to be selected or can be neither displayed nor grayed out. The purpose of preventing a raised game medium from being selected as an inherited game medium in this way in the case where the raising game medium and the raised game medium are based on the common material game medium is to ensure gameplay. This grayed-out display can be done, for example, by associating the ID of the material game medium selected as the raising game medium with the ID of the raised game medium. Note that although it is not possible to select, as an inherited game medium, a raised game medium having the same character as that of the raising game medium, it is possible to select, as an inherited game medium, a raised game medium (character B here) related to an inheritance-originated ancestral raised game medium having the same character as the character (character A here) of the raising game medium, as shown in the inherited-game-medium temporary selection region R32.

The determination button R34 is a button for selecting, as an inherited game medium, the raised game medium selected in the group-of-raised-game-media display region R33.

The inherited-game-medium confirmation screen G4 includes a raising-game-medium display region R41, inherited-game-medium confirmation regions R42, and a determination button R43.

The raising-game-medium display region R41 is displayed to include the image I1, an inheritance tendency R41a, and an affinity bonus value R41b of the raising game medium. The inheritance tendency R41a indicates property information that is highly likely to be inherited from the two selected inherited game media. The inheritance tendency R41a is displayed by the inherited-game-medium acceptance unit 23b on the display device 13. In one example, the inherited-game-medium acceptance unit 23b regards, as most likely to be inherited, property information that has the highest rank or level among all or predetermined items of property information (e.g., basic ability parameters and/or aptitude parameters) possessed by each of the inherited game media. In another example, the inherited-game-medium acceptance unit 23b obtains property information that is highly likely to be inherited by the raising game medium on the basis of the affinity between the raising game medium and the inherited game media in the case where the selected raised game media are set as inherited game media and displays the obtained property information as the inheritance tendency R41a. For example, the inherited-game-medium acceptance unit 23b identifies, as property information that is highly likely to be inherited, lottery-type information having a corresponding expression probability (described below) that is relatively high among the items of lottery-type information (described below) of each of the inherited game media. In another example, the inherited-game-medium acceptance unit 23b sums, for each item of property information, the tendency values associated with the property information or the ranks/levels thereof of each of the inherited game media and displays, on the display device 13, the type of property information exhibiting the maximum total value as the inheritance tendency R41a. More specifically, a tendency value indicating the inheritance tendency of a predetermined type of property information is associated with each item of property information or the rank/level thereof of each of the inherited game media. For example, if, in the two inherited game media, tendency value 1 indicating the speed is associated with rank 1 of property information indicating the speed, tendency value 2 indicating the speed is associated with rank 2 of property information indicating the speed, tendency value 5 indicating the power is associated with rank 5 of property information indicating the power, tendency value 1 indicating the speed is associated with rank 1 of property information indicating the turf aptitude, and tendency value 2 indicating the power is associated with rank 2 of property information indicating the short-distance aptitude, then the total of the tendency values for the speed is 4, the total of the tendency values for power is 7, and the total of the other tendency values is 0. Thus, power is identified as the type of property information that exhibits the maximum total among all items of property information. Therefore, the power tendency is the inheritance tendency R41a that is displayed on the display device 13 by the inherited-game-medium acceptance unit 23b.

As described below, the affinity bonus value R41b indicates a value obtained by summing the value representing the affinity between the raising game medium and each of the inherited game media and the value representing the affinity between the raising game medium and each of the inheritance-originated ancestral raised game media of each of the inherited game media. The affinity bonus value R41b indicates the degree of influence upon the inheritance of property information of the inherited game media to the raising game medium. The affinity bonus value R41b is displayed on the display device 13 by the inherited-game-medium acceptance unit 23b. That is, the inherited-game-medium acceptance unit 23b calculates and displays an affinity bonus value on the basis of the value associated with the relationship between the raising game medium and the inherited game media and/or the value associated with the relationship between the raising game medium and the inheritance-originated ancestral raised game media in the case where the selected raised game media are set as inherited game media. For example, the inherited-game-medium acceptance unit 23b sums a bonus value corresponding to each of at least one relationship between the raising game medium and the raised game media set as inherited game media and a bonus value corresponding to each of the relationships between the raising game medium and the inheritance-originated ancestral raised game media and displays the resultant value as an affinity bonus value.

The inherited-game-medium confirmation regions R42 are displayed to include images Z1 and property information of the raised game media selected as inherited game media, as well as images ZA1 and ZA2 and property information of the inheritance-originated ancestral raised game media of those inherited game media. In the example shown in FIG. 7, because two inherited game media are selected, two inherited-game-medium confirmation regions R42 are displayed on the display device 13.

The determination button R43 is a button for setting the selected raised game media as inherited game media. In response to the player pressing the determination button R43, the inherited-game-medium acceptance unit 23b sets the two selected raised game media as inherited game media.

The raising-game execution unit 23c is configured to include the processor 11, executes a raising game, changes a raising parameter on the basis of at least one item of property information possessed by the inherited game media, and generates a raised game medium by associating the raising parameter with the character ID included in the raising game medium at the time of completion of the raising game.

A raising game is a game in which a raising game medium is raised and in which raising parameters indicating abilities, skills, etc. associated with the raising game medium are changed through training of the raising game medium and through inheritance based on the property information of inherited game media. A raising game has raising parameters associated with the raising game medium, more specifically, the character ID included in the raising game medium. The raising game may have consumption-type parameters associated with the raising game medium, more specifically the character ID included in the raising game medium. A consumption-type parameter is a value that is used and consumed by the player during a raising game and is valid only during the raising game. In one example, in the case where there is an ability or a skill that can be acquired in exchange for a predetermined number of points through training during a raising game, the predetermined number of points necessary to acquire the ability or skill is discounted or reduced by consuming a consumption-type parameter. In another example, a consumption-type parameter is physical strength of the character in a raising game, said character being identified by the raising game medium, more specifically, the character ID included in the raising game medium. The consumption-type parameter indicating the physical strength is reduced through training in the raising game. Because a consumption-type parameter is a variable that varies in the raising game, the consumption-type parameter can be considered to be a type of raising parameter. That is, a consumption-type parameter, as a predetermined value, may be associated with property information of at least one of the material game medium, the raised game medium, and the inherited game medium.

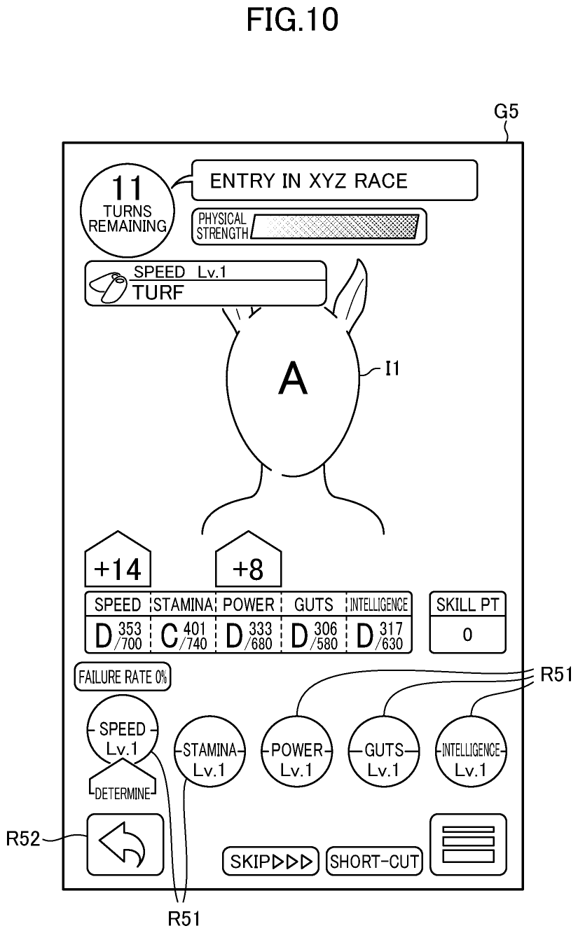

FIG. 10 is a training command selection screen for training the raising game medium in a raising game. A training command selection screen G5 is a screen for training the raising game medium that is displayed on the display device 13 by the raising-game execution unit 23c. The training command selection screen G5 is displayed as a result of being transitioned from a home screen (not shown in the figure) when the raising-game execution unit 23c receives a signal indicating that the player has pressed a training button on the home screen. The image I1 and raising parameters of the raising game medium, training command buttons R51, and a return button R52 are displayed on the training command selection screen G5. As the raising parameters: basic ability parameters indicating the speed, stamina, power, guts, and intelligence; skill points (skill pt) used to acquire a skill; and a consumption-type parameter indicating the physical strength of the raising game medium are displayed.

Here, the training command buttons R51 are buttons for increasing the raising parameters corresponding to the basic ability parameters. In one example, the player pressing a training command button R51 causes the raising parameter corresponding to the pressed button R51 to increase. For example, the raising parameter indicating the speed is increased by a predetermined amount by pressing the training command button R51 for speed. In addition, the number of raising parameters that are increased with one training command button R51 may be two or more. For example, in the example shown in FIG. 10, the training command button R51 for speed causes the raising parameters indicating the speed and power to be increased by predetermined amounts of +14 and +8, respectively. A consumption-type parameter may be changed, such as reducing the consumption-type parameter indicating the physical strength and increasing the consumption-type parameter indicating the skill, by pressing a training command button R51. The failure rate of the training shown in FIG. 10 is determined by the raising-game execution unit 23c, depending on the consumption-type parameter indicating the physical strength. In one example, the larger the value of the consumption-type parameter indicating the physical strength, the lower the failure rate and the easier it is to obtain a predetermined variation amount, and the smaller the value of the parameter, the higher the failure rate and the more difficult it is to obtain a predetermined variation amount. The consumption-type parameter indicating the physical strength can be recovered by a break in the raising game medium. The number of times training is performed during the raising game can be a predetermined number of times (e.g., once) in a predetermined period (e.g., one turn) in the raising game scenario. The return button R52 is a button for returning to the home screen and causes the training command selection screen G5 to transition to the home screen by means of the raising-game execution unit 23c.

Note that although the character ID of the raising game medium and the raising parameters are managed separately from each other in this embodiment, the raising-game execution unit 23c can demonstrate as if the character ID were associated with the raising parameters by displaying the image I1 associated with the character ID, together with the raising parameters, on the training command selection screen G5.

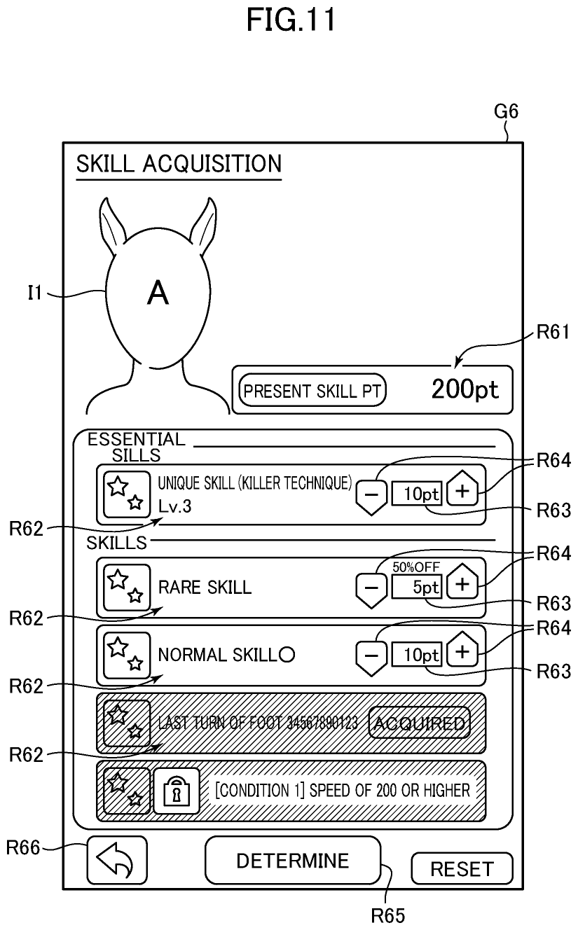

FIG. 11 is a skill acquisition screen in a raising game. A skill acquisition screen G6 is a screen for varying (increasing) the raising parameters indicating skills associated with the raising game medium and is a screen that is displayed on the display device 13 as a result of being transitioned from the home screen when the raising-game execution unit 23c receives a signal indicating that the player has pressed a skill acquisition button included in the home screen. The image I1 of the raising game medium, possessed skill points R61, skills R62 that are to be acquired or have been acquired, skill points R63 used to acquire or upgrade skills, increase/decrease buttons R64 for skill points used for intended skills, a determination button R65, and a return button R66 are displayed on the skill acquisition screen G6. Upon receiving a signal indicating that skill points to be consumed have been selected with an increase/decrease button R64 and the determination button R65 has been pressed, the raising-game execution unit 23c varies the raising parameter indicating the relevant skill. After the completion of the raising game, the result of this variation can be carried over as one of the items of property information of the raised game medium. The return button R66 is a button for returning to the home screen when pressed by the player after the end of skill acquisition.

At least one item of property information possessed by an inherited game medium includes expression-defined-type information the effect of which is expressed definitely upon the start of a raising game and lottery-type information the effect of which is expressed on the basis of a probability-based lottery executed at a predetermined timing during the raising game. The word expression means to vary a raising parameter on the basis of the relevant property information. Expression-defined-type information is property information that is tied to a predetermined variation amount by which the corresponding raising parameter is varied and includes, for example, the basic ability parameters and the aptitude parameters. Lottery-type information includes, for example, a race factor indicating that the horse has won in a predetermined race and a skill factor indicating that the horse has a predetermined skill. Lottery-type information may include property information included in expression-defined-type information, such as a basic ability parameter and an aptitude parameter. That is, a predetermined parameter can be both expression-defined-type information and lottery-type information.

A consumption-type parameter that is valid only in a raising game may be associated with at least one item of property information possessed by an inherited game medium. A consumption-type parameter associated with a raising game medium may be varied on the basis of a consumption-type parameter of an inherited game medium. In one example, the consumption-type parameter indicating the physical strength of a raising game medium (more specifically, character identified by the character ID included in the raising game medium) can be recovered (increased) on the basis of the consumption-type parameter indicating the physical strength of an inherited game medium. A consumption-type parameter may be one of the items of lottery-type information. In this case, the consumption-type parameter can be considered to be one type of raising parameter.

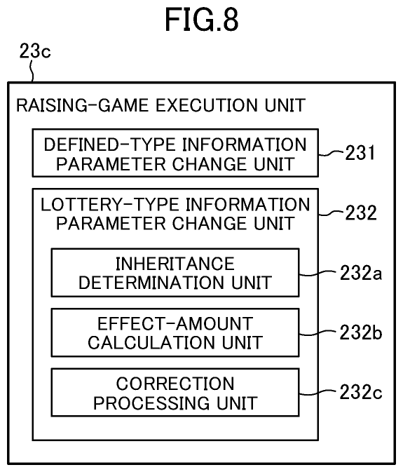

FIG. 8 is an example of a functional block diagram of the raising-game execution unit. As shown in FIG. 8, the raising-game execution unit 23c has a defined-type information parameter change unit 231 and a lottery-type information parameter change unit 232.

The defined-type information parameter change unit 231 changes the raising parameter corresponding to expression-defined-type information of an inherited game medium. In the case where property information indicating the speed of an inherited game medium is expression-defined-type information, in one example, the defined-type information parameter change unit 231 adds an effect amount (additional amount of speed) determined on the basis of the parameter indicating the speed of the inherited game medium to the raising parameter indicating the speed. More particularly, a table in which ranks such as rarities are associated with predetermined values for each type of defined-type information (e.g., table in which rank 1 is associated with a value of 3, rank 2 is associated with a value of 5, and rank 3 is associated with a value of 10) is pre-stored in the storage device 14, so that the defined-type information parameter change unit 231 adds the predetermined value corresponding to the rank of each item of defined-type information of the inherited game medium to the raising parameter corresponding to the relevant defined-type information.

In the same manner, the defined-type information parameter change unit 231 changes the raising parameter corresponding to expression-defined-type information of each of the inheritance-originated ancestral raised game media of the inherited game medium. In this embodiment, the addition amount to be added to the raising parameter corresponding to defined-type information for each item of defined-type information is the total value of the predetermined values associated with the ranks of the relevant defined-type information of the inherited game media and the predetermined values associated with the ranks of the relevant defined-type information of the ancestral raised game media. In this embodiment, because two inherited game media and four ancestral raised game media are tied to a raising game medium, the addition amount is the total value of six predetermined values.

A change in parameter by means of the defined-type information parameter change unit 231 may be made when a raising game is started, at a predetermined timing while the raising game is in progress, or in a time period from when an inherited game medium is determined to when the raising game is completed.

The lottery-type information parameter change unit 232 changes the raising parameter corresponding to each item of lottery-type information on the basis of the result of a probability-based lottery. More specifically, the lottery-type information parameter change unit 232 has an inheritance determination unit 232a, an effect-amount calculation unit 232b, and a correction processing unit 232c.

The inheritance determination unit 232a determines, for each item of lottery-type information, whether or not to change the raising parameter corresponding to the relevant lottery-type information on the basis of the expression probability corresponding to the relevant lottery-type information. In one example, the inheritance determination unit 232a determines whether or not lottery-type information of an inherited game medium is inherited by the raising game medium on the basis of the expression probability associated with that lottery-type information. Inheritance here is a change in the raising parameter corresponding to lottery-type information of the inherited game medium. That is, in the case where the effect of lottery-type information is expressed on the basis of an expression probability, it is determined that the raising parameter corresponding to that lottery-type information is changed, and in the case where the effect of lottery-type information is not expressed on the basis of an expression probability, it is determined that the raising parameter corresponding to that lottery-type information is not changed. An expression probability can be preset, for example, for each of the ranks of each item of lottery-type information (e.g., rank 1 can be assigned 30%, rank 2 can be assigned 40%, and rank 3 can be assigned 50% for expression probabilities of a certain type of a basic ability parameter), and these settings can be pre-stored in the form of a table in the storage device 14. Furthermore, an expression probability can be set for each type of lottery-type information.

The effect-amount calculation unit 232b calculates an effect amount associated with lottery-type information the raising parameter of which has been determined to be changed on the basis of a lottery in the inheritance determination unit 232a. In this embodiment, this effect amount is determined on the basis of weights for effect amounts. Weights for effect amounts are information in which the horizontal axis is represented by effect amounts (e.g., 1, 2, 3, etc.) and the vertical axis is represented by probabilities and, in one example, form a probability distribution in which each of the effect amounts is assigned a probability. The weights for effect amounts may be weights according to the ranks of each item of lottery-type information, as shown in Table 1. Table 1 shows weights for the effect amounts for basic abilities serving as lottery-type information. The numerical values for the weights shown in Table 1 are relative values. For example, in the case of rank 1, the weights are most likely to cause an effect amount of 1 and least likely to cause an effect amount of 10. The weights for effect amounts are pre-stored in the storage device 14, so that the effect-amount calculation unit 232b identifies lottery-type information and the rank thereof tied to an inherited game medium and reads, from the storage device 14, the weights corresponding to the rank of the identified lottery-type information, thereby calculating an effect amount.

Furthermore, the effect-amount calculation unit 232b adds the effect amount calculated for each item of lottery-type information to the corresponding raising parameter.

TABLE 1

| Type of lottery- | Effect | Weights | | |
|---|---|---|---|---|
| type information | amounts | Rank 1 | Rank 2 | Rank 3 |
| Basic abilities | 1 | 100 | 60 | 10 |
| | 2 | 90 | 70 | 20 |
| | 3 | 80 | 80 | 30 |
| | 4 | 70 | 90 | 40 |
| | 5 | 60 | 100 | 60 |
| | 6 | 50 | 80 | 80 |
| | 7 | 40 | 70 | 90 |
| | 8 | 30 | 50 | 100 |
| | 9 | 20 | 30 | 50 |
| | 10 | 10 | 20 | 30 |

The correction processing unit 232c corrects the expression probabilities corresponding to lottery-type information on the basis of the affinity between the raising game medium and the inherited game medium. This affinity is a relationship between the raising game medium and the inherited game medium and includes at least one relationship. A predetermined affinity bonus value is set to each of the relationships, and the correction processing unit 232c multiplies, for each item of lottery-type information, a preset expression probability of the relevant lottery-type information by a weight coefficient reflecting the affinity bonus value, i.e., (1+the total of the affinity bonus values set to the relationships of the relevant lottery-type information/100). The value obtained in this manner is used by the lottery-type information parameter change unit 232 (inheritance determination unit 232a) as an expression probability of the relevant lottery-type information.

Relationships between a raising game medium and an inherited game medium, although depending on the scenario and the worldview of the raising game, include, for example, a colleague relationship, a rival relationship, and a relationship between winners in the same race. The affinity bonus value for each of the relationships can be set, as appropriate, and may be a positive value or a negative value. Relationships between a raising game medium and an inherited game medium and the affinity bonus value for each of the relationships are pre-stored in the storage device 14 such that the IDs of the game media establishing the relationships are associated with the affinity bonus values, and the correction processing unit 232c can read out various types of information from the storage device 14, as needed.

The raising-game execution unit 23c may correct the expression probabilities corresponding to lottery-type information of a raised game medium on the basis of the affinity between a raising game medium and each of the inheritance-originated ancestral raised game media of each of the inherited game media for the raising game medium. The affinity between a raising game medium and an ancestral raised game medium includes at least one relationship. A predetermined affinity bonus value is set to each of the relationships, and the raising-game execution unit 23c multiplies, for each item of lottery-type information of an ancestral raised game medium, a weight coefficient reflecting the affinity bonus value, i.e., (1+the total of the affinity bonus values set to the relationships of the relevant lottery-type information/100) by a preset expression probability of the relevant lottery-type information. The value obtained in this manner is used by the lottery-type information parameter change unit 232 (inheritance determination unit 232a) as an expression probability of the relevant lottery-type information, so that property information of not only the inherited game media but also the ancestral raising game media can be counted for variations in raising parameters.

In one example, in the case where the property indicating the speed is one of the items of lottery-type information, the raising-game execution unit 23c, by means of the lottery-type information parameter change unit 232, not only changes the raising parameter indicating the speed on the basis of the lottery-type information indicating the speed of each of the inherited game media but also changes the raising parameter indicating the speed on the basis of the lottery-type information indicating the speed of each of the ancestral raised game media.

The raised-game-medium addition unit 23d is configured to include the processor 11 and adds, to the group of raised game media as a raised game medium, a raising game medium the raising of which has been completed by the raising-game execution unit 23c in a raising game. That is, the raised-game-medium addition unit 23d adds, to the group of raised game media, a raised game medium generated at the time of completion of a raising game in the raising-game execution unit 23c. The raised game medium here is stored in the storage device 14 such that a unique ID of a type different from the IDs of the material game medium and the raising game medium, the same character ID as that of the material game medium selected by the player, and the property information having the raising parameter values at the time of completion of the raising game are associated with each other by the raising-game execution unit 23c.

In one example, the raised-game-medium addition unit 23d adds, to the group of raised game media, a raised game medium generated as a result of the n-th raising game being completed such that the relevant raised game medium can be set as an inherited game medium in the (n+1)-th and subsequent raising games. By doing so, a raised game medium raised in a certain raising game can be set not only as a choice for an inherited game medium in subsequent raising games but also as a choice for a game medium to be used in a main competition game.

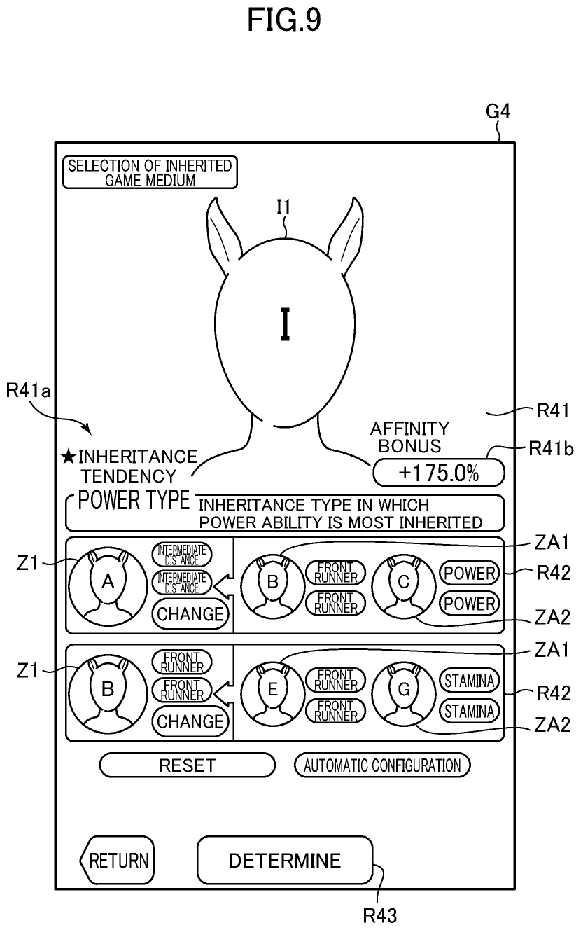

FIG. 9 is another example of the inherited-game-medium confirmation screen. In FIG. 9, a raised game medium (character A) the raising of which has been completed on the basis of the raising game medium shown in FIG. 7 is set as an inherited game medium. That is, the raising game medium raised in the raising game in FIG. 7 (i.e., raised game medium (character A)) is set as an inherited game medium in the raising game in FIG. 9 and is displayed in the upper one of the upper and lower (two) inherited-game-medium confirmation regions R42 in FIG. 9.

The other-player-raised-game-medium addition unit 23e is configured to include the processor 11 and adds a raised game medium belonging to another player to the group of raised game media. A raised game medium belonging to another player is a game medium the raising of which has been completed by the other player in a raising game, such as a game medium the raising of which has been completed in the electronic device 10 possessed by the other player. The other-player-raised-game-medium addition unit 23e acquires a raised game medium raised by another player via the communication device 15 and adds the acquired raised game medium to the current player's group of raised game media by storing the acquired raised game medium as one raised game medium in the current player's group of raised game media.

The main-competition-game execution unit 23f is configured to include the processor 11 and executes a main competition game. A main competition game is, for example, a race. In one example, the main-competition-game execution unit 23f executes a main competition game by using, in the main competition game, a raised game medium selected by the player with the input device 12 from among the group of raised game media. The main-competition-game execution unit 23f displays the progress of the main competition game on the display device 13 while the main competition game is being executed.

### {Operation}

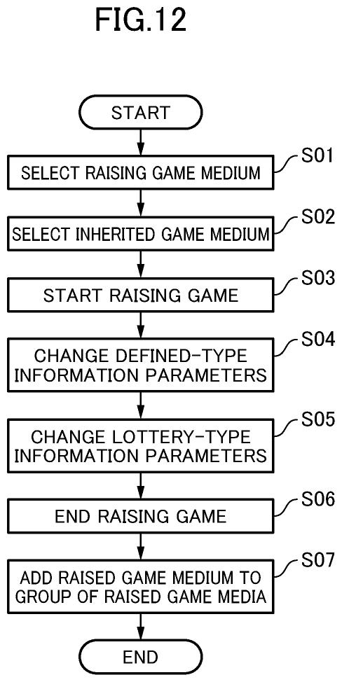

FIG. 12 is an example of a flowchart for the operation of an electronic device according to an embodiment of the present invention. The descriptions below assume that at least two raised game media constituting a group of raised game media are pre-stored in the storage device 14. These raised game media may be ones provided in the system in advance, ones acquired from another player, or ones produced by the player himself/herself by training raising game media in raising games.

The electronic device 10 accepts selection of a raising game medium by means of the raising-game-medium acceptance unit 23a (S01). That is, the raising-game-medium acceptance unit 23a accepts, as a raising game medium, the material game medium selected by the player from the group of material game media. More specifically, the raising-game-medium acceptance unit 23a displays, on the display device 13, the raising-game-medium selection screen G1 shown in FIG. 4 and accepts the selection of one material game medium made by the player via the input device 12, said material game medium being displayed in the group-of-material-game-media display region R12 on the raising-game-medium selection screen G1. The raising-game-medium acceptance unit 23a displays, in the selected-material-game-medium display region R11, the image S1 of the selected material game medium and property information, such as the basic ability parameters and aptitude parameters, of this material game medium. This allows the player to easily select a material game medium to be raised. Then, the raising-game-medium acceptance unit 23a receives a signal indicating that the determination button R13 has been pressed by the player via the input device 12 and accepts the selected one material game medium as a raising game medium.

Next, the inherited-game-medium acceptance unit 23b accepts the player selecting an inherited game medium (S02). More specifically, the inherited-game-medium acceptance unit 23b first receives a signal indicating that a raising game medium has been accepted by the raising-game-medium acceptance unit 23a, displays the inherited-game-medium pre-selection screen G2 shown in FIG. 5 on the display device 13, and accepts, via the input device 12, pressing of the add button R24 in an inherited-game-medium selection region R22. Thereafter, the inherited-game-medium acceptance unit 23b displays, on the display device 13, the inherited-game-medium selection screen G3 shown in FIG. 6 and accepts the selection of one of the raised game media displayed in the group-of-raised-game-media display region R33 on the inherited-game-medium selection screen G3. The inherited-game-medium acceptance unit 23b displays, in the inherited-game-medium temporary selection region R32, the image Z1 and property information of the selected inherited game medium, as well as the images ZA1 and ZA2 and the property information of the inheritance-originated ancestral raised game media of the relevant inherited game medium, and further displays the image I1 and property information of the raising game medium in the raising-game-medium display region R31. By doing so, the player can visually compare property information of the raising game medium with property information of the inherited game medium and thus can easily select an inherited game medium for the raising game medium. Then, the inherited-game-medium acceptance unit 23b accepts, as an inherited game medium, the raised game medium selected by the player pressing the determination button R34 via the input device 12.

Because two inherited game media are set for a raising game in this embodiment, the inherited-game-medium acceptance unit 23b, after having accepted the selection of the first inherited game medium, again displays the inherited-game-medium pre-selection screen G2 on the display device 13. It should be noted, however, that at this time, the image and property information of the selected inherited game medium are displayed in one of the inherited-game-medium selection regions R22 on the inherited-game-medium pre-selection screen G2, in the same manner as in the inherited-game-medium temporary selection region R32. In the same manner as with the selected inherited game medium, the inherited-game-medium acceptance unit 23b accepts selection of another inherited game medium. By doing so, the images, property information, etc. of the selected inherited game media are displayed in both inherited-game-medium selection regions R22 on the inherited-game-medium pre-selection screen G2 in FIG. 5. When the determination button R23 is pressed, the inherited-game-medium acceptance unit 23b displays the inherited-game-medium confirmation screen G4 shown in FIG. 7 on the display device 13.

The inherited-game-medium acceptance unit 23b can accept a change in the selection of an inherited game medium. Any one of the inherited game media can be changed by pressing the change button in the corresponding inherited-game-medium confirmation region R42. Alternatively, both the inherited game media can be changed or reset by pressing the reset button displayed on the inherited-game-medium confirmation screen G4. If these are cases, selection of an inherited game medium is made again on the inherited-game-medium pre-selection screen G2 or the inherited-game-medium selection screen G3.

When neither of the inherited game media need to be changed, the inherited-game-medium acceptance unit 23b receives a signal indicating that the determination button R43 on the inherited-game-medium confirmation screen G4 has been pressed by the player via the input device 12 and accepts the selected raised game media as inherited game media.

After the raising game medium and the inherited game media have been selected, the raising-game execution unit 23c starts a raising game (S03). The raising-game execution unit 23c raises the raising game medium according to a predetermined scenario. As a result of the raising game being started, the defined-type information parameter change unit 231 changes the raising parameters corresponding to expression-defined-type information of the inherited game media and ancestral raised game media (S04). In this embodiment, the defined-type information parameter change unit 231 sums, for each item of expression-defined-type information, the predetermined values corresponding to the ranks of expression-defined-type information of the inherited game media and the ancestral raised game media. Then, the defined-type information parameter change unit 231 adds, for each item of defined-type information, the total amount to the raising parameter corresponding to that defined-type information.

The raising-game execution unit 23c executes an inheritance event a predetermined number of times (e.g., three times) at a predetermined timing while the raising game is in progress. In each of the inheritance events, the lottery-type information parameter change unit 232 changes the raising parameter corresponding to each item of lottery-type information on the basis of the result of a probability-based lottery (S05).

More specifically, upon the occurrence of an inheritance event, the inheritance determination unit 232a determines, for each item of lottery-type information of the inherited game media and the ancestral raised game media, whether or not to change the raising parameter on the basis of the expression probability corresponding to the relevant lottery-type information. In one example, on the basis of the affinity between the raising game medium and the inherited game media, as well as the affinity between the raising game medium and the ancestral raised game media, the correction processing unit 232c first corrects each of the expression probabilities associated with the lottery-type information of the inherited game media and the ancestral raised game media. On the basis of these corrected expression probabilities, the inheritance determination unit 232a determines whether or not to inherit each item of lottery-type information of the inherited game media and the ancestral raised game media to the raising game medium, i.e., whether or not to vary the corresponding raising parameter.

Next, an effect amount is determined for the lottery-type information that has been determined to be inherited by the raising game medium. That is, the effect-amount calculation unit 232b calculates an effect amount associated with the lottery-type information that has been determined to be inherited by the inheritance determination unit 232a. In one example, the effect-amount calculation unit 232b calculates an effect amount to be added to the raising parameter corresponding to each item of lottery-type information of the inherited game media and the ancestral raised game media on the basis of the probability distribution according to the rank associated with the lottery-type information. In addition, the effect-amount calculation unit 232b adds the effect amount calculated for each item of lottery-type information to the raising parameter corresponding to the relevant lottery-type information.

As described above, the total amount for each item of defined-type information acquired by the defined-type information parameter change unit 231 and the addition amount for each item of lottery-type information acquired by the lottery-type information parameter change unit 232 are the variation amount for the raising parameter based on at least one item of property information possessed by the inherited game media and the ancestral raised game media. In one example, the initial value of each of the raising parameters, i.e., the value of each of the raising parameters at the beginning stage of the raising game, is the same as the parameter of the corresponding property information of the material game medium selected by the player. Each of the raising parameters is varied (increased) by adding the total amount and the addition amount indicated by the variation amount to the corresponding initial value. Note that the variation amount for a raising parameter may include an effect amount acquired through training of the raising game medium in the raising game.

When the scenario of the raising game ends, the raising-game execution unit 23c ends the raising game (S06). As a result of the end of the raising game, the raised-game-medium addition unit 23d adds, to the group of raised game media as a raised game medium, the raising game medium the raising of which has been completed in the raising game in steps S03 to S06 (S07). More specifically, the raising-game execution unit 23c generates a raised game medium in which raising game result information resulting from adding the variation amount, including the total amount and the addition amount, to the initial value of each of the raising parameters is tied to the character ID of the raising game medium. Then, the raised-game-medium addition unit 23d stores, in the storage device 14, the generated raised game medium in association with the group of raised game media.

The electronic device 10 sets, as an inherited game medium, the raised game medium acquired through S01 to S07 and can repeat steps S01 to S07 until a raised game medium having property information desired by the player is acquired.

The electronic device 10 can cause the main-competition-game execution unit 23f to display, on the display device 13, the group of raised game media including the raised game medium acquired in S01 to S07, accept the selection of one or more raised game media via the input device 12, and execute a main competition game.

### {Operation and Effect}

(1) The electronic device 10 according to this embodiment is an electronic device for executing a game for raising a game medium in a raising game so that the game medium is used by a player in a main game competition, the electronic device 10 including: the raising-game-medium acceptance unit 23a for accepting a raising game medium that is selected by the player and that is to be raised in the raising game; the inherited-game-medium acceptance unit 23b for accepting, as an inherited game medium, a raised game medium selected from a group of raised game media including a plurality of raised game media the raising of which has been completed by the player in the raising game; and the raising-game execution unit 23c for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game. In particular, in this embodiment, the raising-game-medium acceptance unit 23a is configured to accept, as a raising game medium, the material game medium selected by the player from the group of material game media.

This can improve the fun of the game. For example, in conventional horse race games, the player selects two horses (a stallion and a mare) serving as parents in a so-called breeding process in which two parent horses are crossed to create an offspring horse. In this case, however, because the offspring horse is automatically created by the game program, the player is left with no option and has difficulty creating a desired horse. This embodiment, in contrast, allows the player to select not only an inherited game medium but also a raising game medium to be raised, helping enhance the fun of the game.

(2) The computer is configured to function as the raised-game-medium addition unit 23d for adding, as a raised game medium to the group of raised game media, the raising game medium the raising of which has been completed by the raising-game execution unit 23c in the raising game.

This allows the player to select a raised game medium raised through the raising-game execution unit 23c as an inherited game medium in the next raising game and thus to raise a raising game medium so as to gradually become close to the player's ideal game medium. For example, if the player wishes to create a raised game medium advantageous in a short distance race, the player can create a raised game medium having property information of the short distance in the n-th (n is a natural number) raising game and then, in the (n+1)-th raising game, can not only select a raising game medium having property information of the short distance but also select, as an inherited game medium, the raised game medium having property information of the short distance. Thus, the player can create a raised game medium advantageous in the short distance race or specialized for the short distance race. In addition, after creating a raised game medium having predetermined property information, such as property information of the short distance, in the n-th (n is a natural number) raising game, the player can select, as inherited game media in the (n+1)-th and subsequent raising games, not only this raised game medium having predetermined property information, such as property information of the short distance, but also a raised game medium having property information other than the predetermined property information, such as the property information of the short distance. Thus, the player can create a raised game medium specialized for a plurality of properties. Therefore, the player can create a wide variety of raised game media.

(3) The at least one item of property information includes expression-defined-type information the effect of which is expressed definitely upon the start of the raising game, and the raising-game execution unit 23c is configured to have the defined-type information parameter change unit 231 for changing the raising parameter corresponding to the expression-defined-type information of the inherited game medium. This makes it possible to acquire a raised game medium with enhanced properties by starting a raising game.

(4) The at least one item of property information includes lottery-type information the effect of which is expressed on the basis of a probability-based lottery executed at a predetermined timing during the raising game, and the raising-game execution unit 23c is configured to have the lottery-type information parameter change unit 232 for changing the raising parameter corresponding to each item of the lottery-type information on the basis of a result of the lottery.

This allows the player to acquire a raised game medium that exceeds the player's expectations because the parameters are processed by lottery. In addition, because parameters are processed on the basis of a lottery in a state in which the raising game medium is assured of a certain extent of improvement in ability as a result of a predetermined effect amount based on the expression-defined-type information being added to the raising game medium, even if the lottery fails for the property information desired by the player, a certain amount of raising can be secured or the player can acquire a raised game medium that exceeds his/her expectations.

(5) The lottery-type information parameter change unit 232b is configured to have an inheritance determination unit 232a for determining, for each item of the lottery-type information, whether or not to change the raising parameter corresponding to said lottery-type information on the basis of an expression probability corresponding to said lottery-type information. This enhances the fun of the game because the player does not know in advance which property information will be inherited.

(6) The lottery-type information parameter change unit 232b is configured to have the effect-amount calculation unit 232b for calculating an effect amount on the basis of weights for effect amounts that are associated with the determined lottery-type information and that are used to change the raising parameter. This enhances the fun of the game because even if the property information to be inherited is determined, the effect amount to be imparted is not definitive but is determined by weights (e.g., probability distribution).

(7) The lottery-type information parameter change unit 232b is configured to have the correction processing unit 232c for correcting the expression probability corresponding to the lottery-type information on the basis of an affinity between the raising game medium and the inherited game medium. This can provide the player with the fun of thinking about the combination of a raising game medium and an inherited game medium.

(8) The raised game medium has a second raised game medium associated therewith, said second raised game medium being set as the inherited game medium in the raising game in which said raised game medium was raised, and the raising-game execution unit 23c executes the raising game so as to change the raising parameter on the basis of at least one item of property information possessed by the second raised game medium and corrects the expression probability corresponding to the lottery-type information of said second raised game medium on the basis of an affinity between the raising game medium and the second raised game medium.

This makes it possible to raise a raising game medium by taking into account not only the relationship between the raising game medium and an inherited game medium but also the affinity between the raising game medium and an ancestral raised game medium of the inherited game medium (second raised game medium), thereby realizing various types of raising and enhancing the game fun.

(9) The computer is made to function as the raised-game-medium addition unit 23d for adding a raised game medium of another player to the group of raised game media. This allows a variety of raised game media to be created or the player's desired raised game media to be created because a raised game medium not possessed by the player can be acquired from another player and can be used as an inherited game medium.

### {Embodiments Achieved by System}

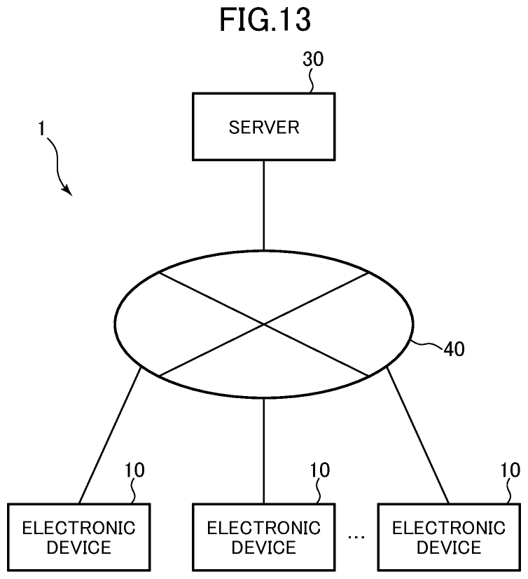

FIG. 13 is a diagram showing an example of the overall structure of a game system according to an embodiment of the present invention. As shown in FIG. 13, a game system 1 includes a plurality of electronic devices 10 and a server 30. Each of the electronic devices 10 is a user terminal used by a player. The electronic devices 10 and the server 30 are connected to a network 40, such as the Internet, so as to be capable of communicating with each other. Note that the game system 1 in this embodiment is described assuming a server-client system but can also be configured as a system, such as P-to-P system, not including the server 30.

Each of the electronic devices 10 includes a hardware configuration similar to the one shown in FIG. 1 and is assumed to be a smartphone in this embodiment. The server 30 is a server device that provides a game executable on the electronic devices 10 and comprises one or more computers.

The server 30 stores various programs, such as control programs for controlling the progress of online games, and various data used in the games.

In one example, the server 30 is configured to be capable of providing the electronic devices 10 with a game application executable on the electronic devices 10. When an electronic device 10 executes a downloaded game application, the electronic device 10 proceeds with the game by transmitting/receiving data to/from the server 30 periodically or as needed. For example, the server 30 stores various types of setting information and history information necessary for the game executed on the electronic device 10. In this case, the electronic device 10 has the functions of the input unit 21, the display unit 22, the game control unit 23, and the functional units in the game control unit 23.

In one example, the server 30 is a web server and provides game services to the electronic devices 10. Each of the electronic devices 10 acquires, from the server 30, HTML data for displaying a web page and analyzes the acquired HTML data to display the web page. In this case, the server 30 communicating with the electronic device 10 has some of the functions of the game control unit 23. For example, the electronic device 10 accepts selection of a raising game medium and inherited game media made by the player via the input unit 21 (input device 12), executes a raising game by means of the raising-game execution unit 23c of the server 30, and executes a main competition game by means of the main-competition-game execution unit 23f of the server 30.

### Other Embodiments

Another embodiment of the present invention can be: a program for realizing the aforementioned functions or the information processing shown in the flowchart of the embodiment according to the present invention; or a computer-readable storage medium containing the program. Still another embodiment can be a method for realizing the aforementioned functions or the information processing shown in the flowchart of the embodiment according to the present invention. Still another embodiment can be a server that is capable of providing a computer with a program for realizing the aforementioned functions or the information processing shown in the flowchart of the embodiment according to the present invention. Still another embodiment can be a virtual machine for realizing the aforementioned functions or the information processing shown in the flowchart of the embodiment according to the present invention.

The processing or operation described above may be modified freely as long as no inconsistency arises in the processing or operation, such as an inconsistency that a certain step utilizes data that should not yet be available in that step. Furthermore, the examples described above are examples for explaining the present invention, and the present invention is not limited to those examples. The present invention can be embodied in various forms as long as there is no departure from the gist thereof.

For example, although the aforementioned embodiments include the other-player-raised-game-medium addition unit 23e, the present invention is not limited to those embodiments but includes an aspect in which the other-player-raised-game-medium addition unit 23e is not provided.

Although the lottery-type information parameter change unit 232 has the inheritance determination unit 232a and the effect-amount calculation unit 232b in the above-described embodiments, the lottery-type information parameter change unit 232 need not have either one of the inheritance determination unit 232a and the effect-amount calculation unit 232b. In the case where the lottery-type information parameter change unit 232 does not have the inheritance determination unit 232a, the effect amount of lottery-type information is determined from a probability-based lottery in the effect-amount calculation unit 232b while the lottery-type information is definitely expressed. In the case where the lottery-type information parameter change unit 232 does not have the effect-amount calculation unit 232b, it is determined by the inheritance determination unit 232a whether or not to change the raising parameter corresponding to lottery-type information. If it is determined that the raising parameter is changed, the effect amount for the raising parameter is a fixed value associated with the relevant lottery-type information by the effect-amount calculation unit 232b.

Although, in the above-described embodiments, parameters of property information regarding a material game medium, a raising game medium, a raised game medium, and an inherited game medium are set not only in the case where the corresponding ability or skill is available but also in the case where the corresponding ability or skill is not available (e.g., by setting a parameter value of 0), a parameter may be defined only in the case where the corresponding ability or skill is available. In this case, if property information to be inherited from an inherited game medium or an ancestral raised game medium thereof by a raising game medium is not available as a raising parameter, processing for defining, as a new variable, a parameter of the property information to be inherited may be performed. In other words, inheritance of at least one item of property information of an inherited game medium or an ancestral raised game medium thereof to a raising game medium means to add, to the corresponding raising parameter, the variation amount based on the property information of the inherited game medium or the ancestral raised game medium thereof, and this addition includes changing the corresponding raising parameter if the type of property information corresponding to the relevant variation amount is available as a raising parameter and newly adding a raising parameter for the type of property information corresponding to the relevant variation amount if the type of property information corresponding to the relevant variation amount is not available.

In the above-described embodiments, in order to preserve a material game medium, when the material game medium is selected as a game medium to be raised, a raising game medium is generated by duplicating the material game medium in, for example, a volatile recording medium such that the material game medium and the raising game medium are treated as separate data in which only the IDs are different. Instead of this, a material game medium may be used as-is for a raising game medium without being duplicated. That is, at least after the completion of a raising game, the material game medium may be overwritten with the result of raising and stored in the storage device 14 as a raised game medium.

In the above-described embodiments, the affinity between a raising game medium and an inherited game medium, as well as the affinity between a raising game medium and an inheritance-originated ancestral raised game medium of the inherited game medium, is reflected by the correction processing unit 232c on expression probabilities in the inheritance determination unit 232a. Instead of this, those affinities may be reflected on a probability distribution in the effect-amount calculation unit 232b. That is, the correction processing unit 232c may correct a probability distribution of the effect amounts on the basis of the affinity between the raising game medium and the inherited game medium and/or the affinity between the raising game medium and the inheritance-originated ancestral raised game medium of the inherited game medium. For example, in the case where each of the relationships between a raising game medium and an inherited game medium or each of the relationships between a raising game and an ancestral raised game medium has a value equal to or larger than a predetermined affinity bonus value, the correction processing unit 232c may perform correction such that the probability of a predetermined effect amount of a probability distribution becomes higher than the probability of another effect amount of the probability distribution. This means to shift the peak of the probability distribution. In one example, the peak of a probability distribution may be shifted towards the larger side of the effect amount such that the probabilities corresponding to the effect amounts equal to or larger than a predetermined value (e.g., effect amounts equal to or larger than 6 in the case of the probability distribution for rank 1 in Table 1) are increased relatively, and the probabilities corresponding to the effect amounts smaller than the predetermined value (effect amounts smaller than or equal to 5) are decreased relatively.

Alternatively, the raising-game execution unit 23c may have a parameter correction unit that increases and decreases a raising parameter on the basis of the affinity between a raising game medium and an inherited game medium. This allows the player to enjoy various combinations between a raising game medium and an inherited game medium that can be selected, thereby enhancing the fun of the game. The parameter correction unit increases and decreases a raising parameter by adding an affinity bonus value (e.g., a positive or negative value) associated with at least one relationship, which is a affinity, to the eigenvalue of the material game medium selected as a raising game medium.

In the above-described embodiments, the character ID of the raising game medium and raising parameters are treated independently of each other during a raising game. Instead of this, the character ID of the raising game medium and raising parameters may be associated with each other at all times.

The main competition game may be a ball game such as baseball, soccer, or tennis, a competitive game such as track and field, a role playing game (RPG), a shooting game, or a puzzle game. In this case, the game medium is, for example, a character representing a player of the ball game or competition or a hero/heroine or a personage related to the hero/heroine.

### REFERENCE SIGNS LIST

1 Game system
10 Electronic device
11 Processor
12 Input device
13 Display device
14 Storage device
15 Communication device
16 Bus
21 Input unit
22 Display unit
23 Game control unit
23a Raising-game-medium acceptance unit
23b Inherited-game-medium acceptance unit
23c Raising-game execution unit
231 Defined-type information parameter change unit
232 Lottery-type information parameter change unit
232a Inheritance determination unit
232b Effect-amount calculation unit
232c Correction processing unit
23d Raised-game-medium addition unit
23e Other-player-raised-game-medium addition unit
23f Main-competition-game execution unit
30 Server
40 Network

1. A non-transitory computer readable medium storing a program that executes a game including a main competition game in which a player uses a game medium and a raising game in which the player raises the game medium, said program causing a computer to function as:
a raising-game-medium acceptance means for accepting a raising game medium that is selected by the player and that is to be raised in the raising game;
an inherited-game-medium acceptance means for accepting, as an inherited game medium, a raised game medium selected from a group of raised game media including a plurality of raised game media the raising of which has been completed by the player in the raising game; and
a raising-game execution means for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.

2. The non-transitory computer readable medium according to claim 1, causing the computer to function as a raised-game-medium addition means for adding, as the raised game medium to the group of raised game media, the raising game medium the raising of which has been completed by the raising-game execution means in the raising game.

3. The non-transitory computer readable medium according to claim 1, wherein the raising-game-medium acceptance means accepts, as the raising game medium, a material game medium selected by the player from a group of material game media.

4. The non-transitory computer readable medium according to claim 1, wherein the at least one item of property information includes expression-defined-type information the effect of which is expressed definitely upon the start of the raising game.

5. The non-transitory computer readable medium according to claim 4, wherein the raising-game execution means has a defined-type information parameter change means for changing the raising parameter corresponding to the expression-defined-type information of the inherited game medium.

6. The non-transitory computer readable medium according to claim 1, wherein the at least one item of property information includes lottery-type information the effect of which is expressed on the basis of a probability-based lottery executed at a predetermined timing during the raising game.

7. The non-transitory computer readable medium according to claim 6, wherein the raising-game execution means has a lottery-type information parameter change means for changing the raising parameter corresponding to each item of the lottery-type information on the basis of a result of the lottery.

8. The non-transitory computer readable medium according to claim 7, wherein the lottery-type information parameter change means has an inheritance determination means for determining, for each item of the lottery-type information, whether or not to change the raising parameter corresponding to said lottery-type information on the basis of an expression probability corresponding to said lottery-type information.

9. The non-transitory computer readable medium according to claim 8, wherein the lottery-type information parameter change means has an effect-amount calculation means for calculating an effect amount on the basis of weights for effect amounts that are associated with the determined lottery-type information and that are used to change the raising parameter.

10. The non-transitory computer readable medium according to claim 8, wherein the lottery-type information parameter change means has a correction processing means for correcting the expression probability corresponding to the lottery-type information on the basis of an affinity between the raising game medium and the inherited game medium.

11. The non-transitory computer readable medium according to claim 8, wherein the raised game medium has a second raised game medium associated therewith, said second raised game medium being set as the inherited game medium in the raising game in which said raised game medium was raised, and
the raising-game execution means executes the raising game so as to change the raising parameter on the basis of at least one item of property information possessed by the second raised game medium and corrects the expression probability corresponding to the lottery-type information of said second raised game medium on the basis of an affinity between the raising game medium and the second raised game medium.

12. The non-transitory computer readable medium according to claim 1, wherein the raising-game execution means has a parameter correction means for increasing and decreasing the raising parameter on the basis of an affinity between the raising game medium and the inherited game medium.

13. The non-transitory computer readable medium according to claim 1, causing the computer to function as the raised-game-medium addition means for adding the raised game medium of another player to the group of raised game media.

14. A method for executing, by means of an electronic device, a game for raising a game medium in a raising game so that the game medium is used by a player in a main game competition, said method comprising:
a raising-game-medium acceptance step for accepting a raising game medium that is selected by the player and that is to be raised in the raising game;
an inherited-game-medium acceptance step for accepting, as an inherited game medium, a raised game medium selected from a group of raised game media including a plurality of raised game media the raising of which has been completed by the player in the raising game; and
a raising-game execution step for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.

15. A system for executing a game for raising a game medium in a raising game so that the game medium is used by a player in a main game competition, said system comprising:
a user terminal; and
a server connected to the user terminal via a network,
wherein the user terminal or the server functions as a raising-game-medium acceptance means for accepting a raising game medium that is selected by the player and that is to be raised in the raising game,
the user terminal or the server functions an inherited-game-medium acceptance means for accepting, as an inherited game medium, a raised game medium selected from a group of raised game media including a plurality of raised game media the raising of which has been completed by the player in the raising game, and
the user terminal or the server functions as a raising-game execution means for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.

16. An electronic device for executing a game for raising a game medium in a raising game so that the game medium is used by a player in a main game competition, said electronic device comprising:
a raising-game-medium acceptance means for accepting a raising game medium that is selected by the player and that is to be raised in the raising game;
an inherited-game-medium acceptance means for accepting, as an inherited game medium, a raised game medium selected from a group of raised game media including a plurality of raised game media the raising of which has been completed by the player in the raising game; and
a raising-game execution means for executing the raising game in which the raising game medium is to be raised, changing a raising parameter varying in the raising game on the basis of at least one item of property information possessed by the inherited game medium, and generating the raised game medium by associating a character ID included in the raising game medium with the raising parameter upon completion of the raising game.
